(19) United States
(12) Patent Application Publication
(10) Pub. No.: US 2016/0282653 A1
(43) Pub. Date: Sep. 29, 2016

(54) TOUCH TYPE LIQUID CRYSTAL DISPLAY APPARATUS AND MANUFACTURING METHOD FOR THE SAME

(71) Applicants: BOE TECHNOLOGY GROUP CO., LTD., Beijing (CN); HEFEI XINSHENG OPTOELECTRONICS TECHNOLOGY CO. LTD., Anhui (CN)

(72) Inventors: Ming Hu, Beijing (CN); Guodong Liu, Beijing (CN)

(21) Appl. No.: 14/892,631

(22) PCT Filed: Feb. 27, 2015
(86) PCT No.: PCT/CN2015/073343

§ 371 Date: Nov. 20, 2015

(30) Foreign Application Priority Data
Nov. 13, 2014 (CN) 201410640401.3

(51) Int. Cl. G02F 1/1333; G06F 3/041; G02F 1/1335

(52) U.S. Cl. CPC G02F 1/13338; G02F 1/133512; G06F 3/041; G02F 2202/28; G06F 2203/04103

(57) ABSTRACT

Embodiments of the present invention provide a touch type liquid crystal display apparatus, comprising a touch screen, a liquid crystal display screen, and an adhesion layer between the touch screen and the liquid crystal display screen. The adhesion layer comprises a plurality of adhesion parts being not in contact with each other, and the adhesion parts are in contact with the touch screen and the liquid crystal display screen, respectively, for fixation of the touch screen with the liquid crystal display screen. Compared to the prior art, the touch type liquid crystal display apparatus has a reduced production cost, and effectively alleviates the whitening phenomenon of the touch display. Embodiments of the present invention also provide a method for manufacturing a touch type liquid crystal display apparatus, which is adopted to produce the abovementioned touch type liquid crystal display apparatus.

### CROSS-REFERENCE TO RELATED APPLICATION

This application is a Section 371 National Stage Application of International Application No. PCT/CN2015/073343, filed 27 Feb. 2015, entitled “TOUCH TYPE LIQUID CRYSTAL DISPLAY APPARATUS AND MANUFACTURING METHOD FOR THE SAME”, which claims priority to Chinese Application No. 201410640401.3, filed on Nov. 13, 2014, incorporated herein by reference in their entirety.

### BACKGROUND

1. Technical Field

The disclosure relates to the field of display technologies, and particularly, to a touch type liquid crystal display apparatus and a manufacturing method for the same.

2. Description of the Related Art

A touch display is capable of being operated by touching an icon or a character on the display screen only with user's finger, which enables a more straightforward human-computer interaction. Nowadays, the touch display is widely used in all aspects of social activities.

As shown in FIG. 1, the touch display generally comprises a touch screen 10A and a liquid crystal display screen 20A, and the touch screen 10A and the liquid crystal display screen 20A are bonded by adhesive 30A, wherein the liquid crystal display screen 20A generally comprises a color film substrate 21A, an array substrate 22A, and liquid crystals 23A between the color film substrate 21A and the array substrate 22A.

The liquid crystal display screen's display principle is as follows. After the liquid crystal display screen is energized, electrical field is established around the liquid crystal. Under the action of the electrical field, the liquid crystal rotates. Different intensities of the electrical field cause different angles of rotation of the corresponding liquid crystal, which leads to different light transmissions, thereby achieving the displaying of different gray levels. In prior art, an electrical field is generally established once the common electrode and the pixel electrode are energized. The common electrode and the pixel electrode may be located at the same side of the liquid crystals, or may be located at different sides of the liquid crystals.

In case that the common electrode and the pixel electrode are located at the same side of the liquid crystals, the inventor has found that there has been at least the following problem. As shown in FIG. 2, during a bending test of the touch display, once the touch screen 10A is exerted by external force to be deformed, some components of the external force are transferred to the adhesive 30A. However, the adhesive 30A cannot absorb deformation energy of the touch screen 10A nicely, which leads to some components of the external force are transferred to the liquid crystal display screen 20A. In the liquid crystal display screen 20A, the liquid crystal 23A will absorb some of the deformation energy due to existence of the liquid crystal 23A between the array substrate 22A and the color film substrate 21A.

Correspondingly, since magnitude of the force transferred to the array substrate 22A is different from that transferred to the color film substrate 21A, rates of deformation of the array substrate 22A and the color film substrate 21A are different. As a result, the electrical field, which is established by the pixel electrode 220A and the common electrode 221A located at the same side of the liquid crystals 23A, is prone to change under the influence of deformations of the array substrate 22A and the color film substrate 21A, which disrupts arrangement of the liquid crystals, thereby leads to light leakage so as to adversely affect the display effect. For example, if a bending test is conducted on the touch display when the touch display is displaying a black or gray picture, a region of the liquid crystal display screen which corresponds to a bent section of the touch display will have a light leakage, as a result, this region will display a white color, which is known as a whitening phenomenon.

At present, a thinned liquid crystal display screen is adopted to solve the whitening phenomenon, although the liquid crystal display screen after the assembling should be thinned during a manufacture of the liquid crystal display screen. This adds an addition process, which increases the production cost. Moreover, the thinning will easily damage the liquid crystal display screen, which reduces the production yield.

### SUMMARY

Embodiments of the present invention provide a touch type liquid crystal display apparatus. The touch type liquid crystal display apparatus comprises a touch screen, a liquid crystal display screen, and an adhesion layer between the touch screen and the liquid crystal display screen. The adhesion layer comprises a plurality of adhesion parts being not in contact with each other, and the adhesion parts are in contact with the touch screen and the liquid crystal display screen, respectively, for fixation of the touch screen with the liquid crystal display screen.

Embodiments of the present invention provide a method for manufacturing a touch type liquid crystal display apparatus. The method comprises steps of: forming a touch screen and a liquid crystal display screen, respectively; forming an adhesion layer on one of the touch screen and the liquid crystal display screen, and implementing a precuring treatment on the adhesion layer, wherein the adhesion layer comprises a plurality of adhesion parts being not in contact with each other; assembling the touch screen with the liquid crystal display screen; and, implementing a curing treatment on the adhesion layer so that the touch screen is fixed with the liquid crystal display screen through the adhesion parts.

### BRIEF DESCRIPTION OF THE DRAWINGS

In order to illustrate clearly the technical solutions in embodiments of the present invention or in the prior art, the accompanying drawings which will be used during describing the embodiments or the prior art are provided and briefly described herein. Obviously, the accompanying drawings for the below description are presented merely for some embodiments of the present invention, and those skilled in the art will easily obtain other accompanying drawings based on the below drawings without involving any inventive labour.

FIG. 1 is a structural schematic view of a touch type liquid crystal display apparatus in prior art;

FIG. 2 is a structural schematic view of a touch type liquid crystal display apparatus in prior art, when being suffered from external force;

FIG. 3 is a structural schematic view of a touch type liquid crystal display apparatus according to an embodiment of the present invention;

FIG. 4 is a top view of an adhesion layer shown in FIG. 3;

FIG. 5 is a flow diagram of a method for manufacturing a touch type liquid crystal display apparatus according to an embodiment of the present invention; and

FIG. 6 is a flow diagram of a method for manufacturing an adhesion layer in a touch type liquid crystal display apparatus according to an embodiment of the present invention.

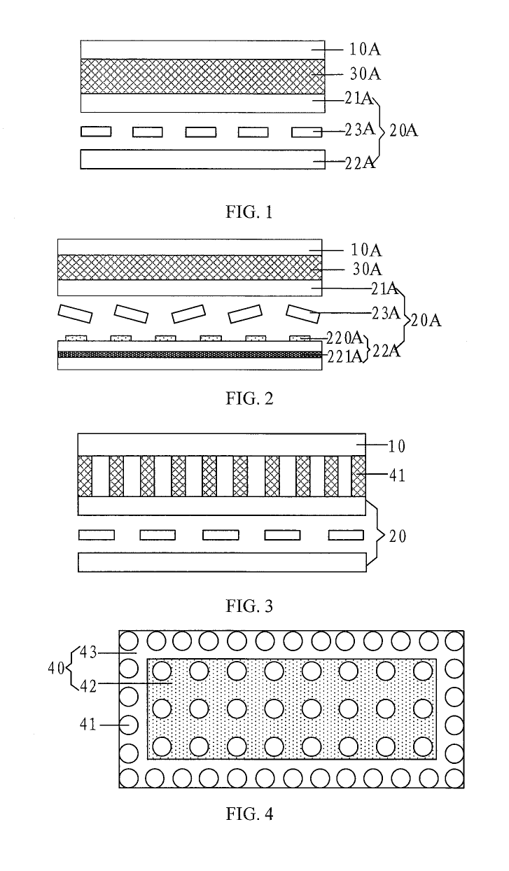

### REFERENCE SIGNS

10/10A—touch screen; 20/20A—liquid crystal display screen; 21A—color film substrate; 22A—array substrate; 220A—pixel electrode; 221A—common electrode; 23A—liquid crystal; 30A—adhesive; 40—adhesion layer; 41—adhesion part; 42—first region; and, 43—second region.

### DETAILED DESCRIPTION OF THE EMBODIMENTS

A clear and complete description of technique solutions of these embodiments of the present invention will be provided in conjunction with abovementioned drawings in the embodiments. Obviously, the depicted embodiments are merely some of these embodiments of the present invention, instead of all of these embodiments of the present invention. Any other embodiments obtained, on the basis of the embodiments of the present invention without involving any inventive labour, by those skilled in the art fall within the scope of the present invention.

Embodiments of the present invention provide a touch type liquid crystal display apparatus. Referring to FIGS. 3 and 4, the touch type liquid crystal display apparatus comprises a touch screen 10, a liquid crystal display screen 20, and an adhesion layer 40 between the touch screen 10 and the liquid crystal display screen 20. The adhesion layer 40 comprises a plurality of adhesion parts 41 being not in contact with each other, and the adhesion parts 41 are in contact with the touch screen 10 and the liquid crystal display screen 20, respectively 10, for fixation of the touch screen 10 with the liquid crystal display screen 20.

In the abovementioned touch type liquid crystal display apparatus, the adhesion parts just need to fix the touch screen with the liquid crystal display screen. Quantity, material, size, height and shape of the adhesion parts are not limited in the present invention, and they may be determined in accordance with practical requirements. In addition, the present invention also does not make any limitations on types of the liquid crystal display screen, as long as the common electrode and the pixel electrode of the liquid crystal display screen are located at the same side of the liquid crystals. For example, it may be an Advanced Super Dimension Switch (ADS) type liquid crystal display screen, or else may be an In-Plane Switching (IPS) type liquid crystal display screen, and so on.

In the touch type liquid crystal display apparatus according to embodiments of the present invention, the adhesion layer is disposed between the touch screen and the liquid crystal display screen. The adhesion layer comprises a plurality of adhesion parts being not in contact with each other, and the adhesion parts are in contact with the touch screen and the liquid crystal display screen, respectively, for fixation of the touch screen with the liquid crystal display screen. Once an external force is exerted on the touch screen so that the touch screen is deformed, since the adjacent adhesion parts are not in contact with each other, on one hand, deformation energy from the touch screen is dispersed to these independent adhesion parts and the deformation energy to be absorbed by each of the adhesion parts becomes small; and on the other hand, existence of gaps between the adjacent adhesion parts makes these adhesion parts to have enhanced ability of absorbing deformation energy. As a result, the adhesion parts are capable of absorbing most of deformation energy from the touch screen, while only a little of deformation energy will be transferred to the liquid crystal display screen, which effectively alleviates the whitening phenomenon of the touch display. In addition, in such display apparatus, no thinning process is needed to be implemented on the liquid crystal display screen, which reduces a production cost.

Moreover, for saving of the material, the adhesion parts each have a height of 0.15 mm-0.5 mm.

Optionally, in order to disperse the deformation energy from the touch screen evenly, a section, along a direction parallel to the liquid crystal display screen, of each of the adhesion parts may be in the shape of circle, ellipse or rectangle.

Optionally, intervals between any two adjacent adhesion parts in a same direction are equal to one another. As a result, uniform distribution of the adhesion parts is more beneficial to fixation between the touch screen and the liquid crystal display screen. Meanwhile, it also evenly disperses the deformation energy from the touch screen.

It should be noted that, in the adhesion layer, these adhesion parts may have the same or different sizes and shapes, and they are not limited specifically herein. In order to reduce the processing difficulty, all the adhesion parts preferably have the same size and shape.

Moreover, in order to fix the margin of the touch screen with that of the liquid crystal display screen in a better manner, referring to FIG. 4, the adhesion layer 10 comprises a first region 42 and a second region 43 adjoining each other, wherein the second region 43 is located at a margin of the liquid crystal display screen, and, a density of distribution of the adhesion parts 41 within the second region 43 is greater than a density of distribution of the adhesion parts 41 within the first region 42.

It should be noted that areas, sizes and shapes of the first and second regions are not limited herein, and they may be determined in accordance with practical requirements. The first region and the second region may have the same or different shapes, and, preferably they have the same shape, which is more beneficial to the processing and manufacturing.

The abovementioned density of distribution denotes a ratio of a sum of areas occupied by these adhesion parts to an area of the region where they are located. For example, a density of distribution of the adhesion parts within the first region denotes a ratio of a sum of areas occupied by these adhesion parts within the first region to an area of the first region. In like manner, a density of distribution of the adhesion parts within the second region denotes a ratio of a sum of areas occupied by these adhesion parts within the second region to an area of the second region.

In addition, optionally, the second region may adjoin only a portion of the first region, or may surround the first region. The latter is preferred, as all the margins of the touch screen and the liquid crystal display screen will be fixed in a better manner.

Moreover, for savings of the material and reduction of the cost, the second region has a width of 3 mm-8 mm. In particular, the width may be determined according to size of the display apparatus.

Optionally, the density of distribution of the adhesion parts within the first region is 40%-70%. In this way, the adhesion parts are distributed uniformly within the first region, which is beneficial to dispersal of the deformation energy from the touch screen.

Optionally, the density of distribution of the adhesion parts within the second region is 70%-100%. In this way, it is beneficial to fixation of the touch screen with the liquid crystal display screen, while saving the material.

An explanation will be given by taking a specific embodiment as an example hereafter. For example, in a 14 inch touch notebook computer, the adhesion parts each have a height of 0.25 mm, a section, along a direction parallel to the liquid crystal display screen, of each of the adhesion parts is in the shape of circle having the diameter of 4.0 mm, a density of distribution of the adhesion parts within the first region is 52.5%, a density of distribution of the adhesion parts within the second region is 90%, the second region has a width of 5.0 mm, and all the adhesion parts have the same size and shape. Whitening phenomenon of this touch notebook computer is greatly alleviated and this touch notebook computer has reduced cost.

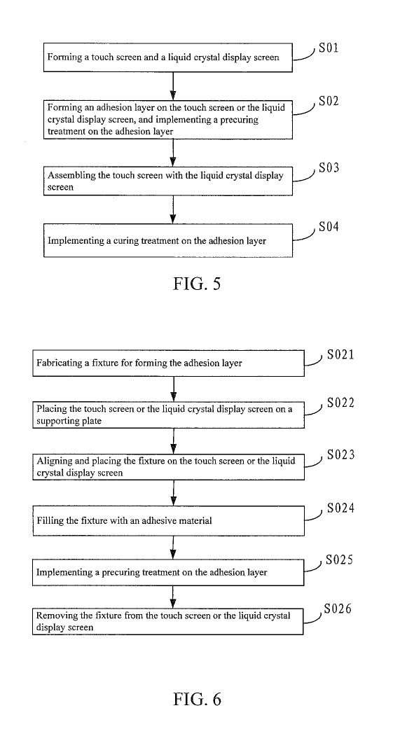

Embodiments of the present invention provide a method for manufacturing a touch type liquid crystal display apparatus. Referring to FIG. 5, the method comprises:

a step S01 of forming a touch screen and a liquid crystal display screen, respectively;

a step S02 of forming an adhesion layer on one of the touch screen and the liquid crystal display screen, and implementing a precuring treatment on the adhesion layer, wherein the adhesion layer comprises a plurality of adhesion parts being not in contact with each other;

a step S03 of assembling the touch screen with the liquid crystal display screen; and

a step S04 of implementing a curing treatment on the adhesion layer so that the touch screen is fixed with the liquid crystal display screen through the adhesion parts.

In the above manufacturing method, the method for manufacturing the touch screen and the liquid crystal display screen is the same as that in the prior art, and will not be described for the sake of brevity herein. In addition, sequence of formations of the touch screen and of the liquid crystal display screen is not limited herein. For example, the touch screen and the liquid crystal display screen may be formed simultaneously, or, the liquid crystal display screen is firstly formed and then the touch screen is formed; or else, the touch screen is firstly formed and then the liquid crystal display screen is formed.

With the method for manufacturing the touch type liquid crystal display apparatus according to embodiments of the present invention, the adhesion layer is formed between the touch screen and the liquid crystal display screen. The adhesion layer comprises a plurality of adhesion parts being not in contact with each other, and the adhesion parts are in contact with the touch screen and the liquid crystal display screen, respectively, for fixation of the touch screen with the liquid crystal display screen. Once an external force is exerted on the touch screen so that the touch screen is deformed, since the adjacent adhesion parts are not in contact with each other, on one hand, deformation energy from the touch screen is dispersed to these independent adhesion parts and the deformation energy to be absorbed by each of the adhesion parts becomes small; on the other hand, existence of gaps between the adjacent adhesion parts makes these adhesion parts to have enhanced ability of absorbing deformation energy. As a result, the adhesion parts are capable of absorbing most of deformation energy from the touch screen, while only a little of deformation energy will be transferred to the liquid crystal display screen, which effectively alleviates the whitening phenomenon of the touch display. In addition, in such manufacturing method, no thinning process is needed to be implemented on the liquid crystal display screen, which reduces production cost.

Moreover, in the abovementioned method, the step of forming an adhesion layer and implementing the precuring treatment on the adhesion layer may further comprise the following steps, as shown in FIG. 6.

In a step S021, a fixture for forming the adhesion layer is fabricated. In particular, the corresponding fixture may be fabricated in accordance with size, height, shape, density, and the like of the adhesion parts. In some embodiment of the present invention, the adhesion parts each have a height of 0.15 mm-0.5 mm. A section, along a direction parallel to the liquid crystal display screen, of each of the adhesion parts is in the shape of circle, ellipse or rectangle. Intervals between any two adjacent adhesion parts in a same direction are equal to one another. Moreover, the adhesion layer may comprise first and second regions adjoining each other, wherein the second region is located at a margin of the liquid crystal display screen, and, a density of distribution of the adhesion parts within the second region is greater than a density of distribution of the adhesion parts within the first region. The second region may adjoin only a portion of the first region, or may surround the first region. The first region and the second region may have the same or different shapes. The second region has a width of 3 mm-8 mm The density of distribution of the adhesion parts within the first region is 40%-70%; and, the density of distribution of the adhesion parts within the second region is 70%-100%.

In a step S022, the touch screen or the liquid crystal display screen is placed on a supporting plate. In particular, the supporting plate may be, for example, a platform of a laminating machine.

In a step S023, the fixture is aligned and placed on the touch screen or the liquid crystal display screen.

In a step S024, the fixture is filled with adhesive material. In particular, the adhesive material may be aqueous adhesive or other adhesives.

In a step S025, a precuring treatment is implemented on the adhesion layer. In particular, for example, the precuring treatment on the adhesion layer may be implemented by use of ultraviolet irradiation.

In a step S026, the fixture is removed from the touch screen or the liquid crystal display screen.

The above description is merely used to illustrate specific embodiments of the present invention, but not to limit the present invention. It would be appreciated by those skilled in the art that, various changes or equivalent alternatives made within the technical scope of the disclosure of the invention should be included within the protection scope of the present invention, the protection scope of which is defined in the claims.

1. A touch type liquid crystal display apparatus, comprising
a touch screen, a liquid crystal display screen, and an adhesion layer between the touch screen and the liquid crystal display screen, wherein:
the adhesion layer comprises a plurality of adhesion parts being not in contact with each other, and the adhesion parts are in contact with the touch screen and the liquid crystal display screen, respectively, for fixation of the touch screen with the liquid crystal display screen.

2. The display apparatus of claim 1, wherein:
the adhesion parts each have a height of 0.15 mm-0.5 mm.

3. The display apparatus of claim 1, wherein:
a section, along a direction parallel to the liquid crystal display screen, of each of the adhesion parts is in the shape of circle, ellipse or rectangle.

4. The display apparatus of claim 1, wherein:
intervals between any two adjacent adhesion parts in a same direction are equal to one another.

5. The display apparatus claim 1, wherein:
the adhesion layer comprises first and second regions adjoining each other, wherein the second region is located at a margin of the liquid crystal display screen, and, a density of distribution of the adhesion parts within the second region is greater than a density of distribution of the adhesion parts within the first region.

6. The display apparatus of claim 5, wherein:
the first region is surrounded by the second region.

7. The display apparatus of claim 6, wherein:
a shape of the second region is the same as a shape of the first region.

8. The display apparatus of claim 7, wherein:
the second region has a width of 3 mm-8 mm.

9. The display apparatus of claim 5, wherein:
the density of distribution of the adhesion parts within the first region is 40%-70%.

10. The display apparatus of claim 5, wherein:
the density of distribution of the adhesion parts within the second region is 70%-100%.

11. A method of manufacturing a touch type liquid crystal display apparatus, comprising steps of:
forming a touch screen and a liquid crystal display screen, respectively;
forming an adhesion layer on one of the touch screen and the liquid crystal display screen, and implementing a precuring treatment on the adhesion layer, wherein the adhesion layer comprises a plurality of adhesion parts being not in contact with each other;
assembling the touch screen with the liquid crystal display screen; and
implementing a curing treatment on the adhesion layer so that the touch screen is fixed with the liquid crystal display screen through the adhesion parts.

12. The method of claim 11, wherein:
the step of forming an adhesion layer and implementing the precuring treatment on the adhesion layer further comprises steps of:
fabricating a fixture for forming the adhesion layer;
placing the touch screen or the liquid crystal display screen on a supporting plate;
aligning and placing the fixture on the touch screen or the liquid crystal display screen;
filling the fixture with an adhesive material;
implementing a precuring treatment on the adhesion layer; and
removing the fixture from the touch screen or the liquid crystal display screen.

13. The method of claim 11, wherein:
the adhesion parts each have a height of 0.15 mm-0.5 mm.

14. The method of claim 11, wherein:
a section, along a direction parallel to the liquid crystal display screen, of each of the adhesion parts is in the shape of circle, ellipse or rectangle.

15. The method of claim 11, wherein:
intervals between any two adjacent adhesion parts in a same direction are equal to one another.

16. The method of claim 11, wherein:
the adhesion layer comprises first and second regions adjoining each other, wherein the second region is located at a margin of the liquid crystal display screen, and, a density of distribution of the adhesion parts within the second region is greater than a density of distribution of the adhesion parts within the first region.

17. The method of claim 16, wherein:
the first region is surrounded by the second region.

18. The method of claim 17, wherein:
a shape of the second region is the same as a shape of the first region.

19. The method of claim 19, wherein:
the second region has a width of 3 mm-8 mm.

20. The method of claim 16, wherein:
the density of distribution of the adhesion parts within the first region is 40%-70%; and, the density of distribution of the adhesion parts within the second region is 70%-100%.
